(19) United States
(12) Patent Application Publication
(10) Pub. No.: US 2026/0326891 A1
(43) Pub. Date: Oct. 22, 2026

(54) COMPACT WHEEL COLUMN DEVICES

(71) Applicant: Safran Electronics & Defense, Avionics USA, LLC, Grand Prairie, TX (US)

(72) Inventors: Andrew Wright, MOISSY-CRAMAYEL (FR); Ryan Fleming, MOISSY-CRAMAYEL (FR)

(73) Assignee: Safran Electronics & Defense, Avionics USA, LLC, Grand Prairie, TX (US)

(21) Appl. No.: 19/158,389

(22) PCT Filed: Mar. 28, 2023
(86) PCT No.: PCT/US2023/065073

§ 371 Date: Aug. 20, 2025

(51) Int. Cl. B64C 13/04; B64C 13/30

(52) U.S. Cl. CPC B64C 13/0423; B64C 13/30

(57) ABSTRACT

Pitch and roll input control devices for aircraft are described that utilize a multi-bar linkage mechanism to translate forward or aft movement of the steering wheel into flight controls in a compact volume. The devices replicate the motion of a large mechanism but use a more compact mechanism that does not require volume below the floor and eliminates the linkage that normally would reside between a pilot's legs.

### FIELD OF THE INVENTION

The field of the invention is wheel column kinematics and devices.

### BACKGROUND

The following description includes information that may be useful in understanding the present invention. It is not an admission that any of the information provided herein is prior art or relevant to the presently claimed invention, or that any publication specifically or implicitly referenced is prior art.

Wheel column pitch and roll inceptors are control devices installed in the cockpit of an aircraft. Typically, the wheel column pitch and roll inceptors use a wheel as the interface between the pilot and the aircraft's flight control system. The wheel column pitch inceptor allows a pilot to control movement of the aircraft including the pitch (nose up/down) and roll (wing up/down). For example, in fly-by-wire systems, when the pilot moves the wheel forward or backward, the pitch inceptor sends a signal to a flight control system, which then moves the aircraft's elevators to achieve the desired pitch change. As another example, when the pilot rotates the wheel, the roll inceptor sends a signal to the flight control system, which then moves the aircraft's ailerons to achieve the desired roll change.

Standard wheel column pitch and roll inceptors can be disadvantageous due to their large size and weight. Traditionally, the wheel column was designed to transmit as much human force as possible to the control surfaces of the aircraft, and the long lever mechanism between the wheel and the axis of rotation below the floor provided the necessary mechanical advantage before the onset of power-assisted and fly-by-wire pilot input.

Examples of wheel column inceptors are described in U.S. Pat. No. 4,778,133 issued on Oct. 18, 1988, U.S. Pat. No. 9,352,824 issued on May 31, 2016, and U.S. Pat. No. 10,246,178 issued on Apr. 2, 2019. All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

While active sidesticks have been used to address size and weight concerns with standard wheel column pitch and roll inceptors, replacing the standard inceptors with active sidesticks would require verification of operation of the sidesticks with many interfacing aircraft control systems. This would also change the pilot input feel and may require additional pilot training.

Thus, there is still a need for wheel column controls that reduce the overall space required while retain the expected wheel column motion for pilot input.

### SUMMARY OF THE INVENTION

The inventive subject matter provides control mechanisms, systems, and devices for a pitch and roll input control for an aircraft by taking an input from a pilot and translating that into a change in the pitch or roll of the aircraft. The pitch and roll input control device is connected to structure of the aircraft which controls aircraft pitch in response to forward or aft movement of the steering or control wheel. Thus, in this manner, the pitch and roll input control device acts as a transfer mechanism to transfer force applied to the steering wheel to cause pitch or roll control of the aircraft.

Contemplated devices comprise a multi-bar linkage mechanism which transfers forward or aft movement of the steering wheel to control structure of the aircraft to thereby cause a change in pitch of the aircraft based on forward or aft movement of the steering wheel.

The pitch and roll input control device is connected to the aircraft such that rotation the steering wheel allows for roll control of the aircraft and translation of the steering wheel (i.e., in a forward or aft direction) allows for pitch control of the aircraft.

The inventive subject matter herein is especially configured for use in commercial aircraft cockpit, although it is contemplated that it could be used in non-commercial or military aircraft as well as other settings where a smaller footprint for the control device would be beneficial.

Contemplated devices comprise a frame or control panel coupled to a steering wheel by a multi-bar linkage mechanism attached to the frame and steering wheel. The linkage mechanism is configured to constrain movement of the steering wheel in a forward or aft direction using a four-bar linkage mechanism while also permitting rotation of the steering wheel about a first axis to control a roll of the aircraft. The four-bar linkage mechanism comprises a plurality of linkages that are coupled together in a specific arrangement such that movement of one of the linkages causes corresponding movement of the other linkages. The device acts as a kinematic mechanism that is advantageously able to reproduce the pitch control motion of the steering wheel as if mounted on a simple lever with the axis of rotation below the floor. The rotational motion of the steering wheel about the wheel axis for roll control is constrained with rotary bearings between the wheel and the linkage mechanism.

It is contemplated that the control device may include mechanical and/or electronic force feedback, and may be physically or electronically interconnected with another control device between pilot stations, for example. Thus, pitch feel can be provided traditionally or with electronics depending on the desired feel.

Using the inventive subject matter described herein, the pitch and roll control device is able to utilize a multi-bar linkage mechanism coupled to the steering wheel to replicate the motion of a large mechanism but using a more compact mechanism that does not require volume below the floor. In addition, the control device is able to maintain pitch kinematic motion while reducing overall weight and volume. In addition, the device offers improved leg clearance for pilots by eliminating the center arm, while maintaining an unobstructed view of instruments on the console.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an exemplary cockpit of a commercial aircraft having a pitch and roll control device as used in the prior art.

FIG. 2 illustrates one embodiment of a pitch and roll control device as shown in a diagram of an aircraft cockpit.

FIG. 3 illustrates another embodiment of a pitch and roll control device.

FIG. 4 illustrates another embodiment of a pitch and roll control device.

FIGS. 5 and 6A-6C illustrate movement of the pitch and roll control device shown in FIG. 4.

FIG. 7 illustrates a diagram of an aircraft cockpit having the pitch and roll control device shown in FIG. 4.

FIGS. 8-9 illustrate various embodiments of coverings for a pitch and roll control device.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

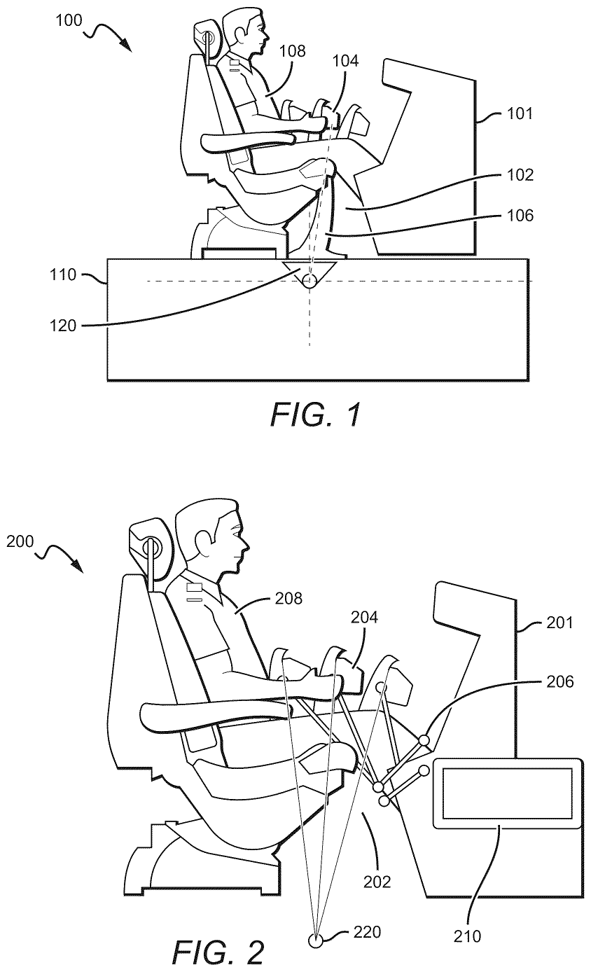

FIG. 1 illustrates an exemplary cockpit 100 of a commercial aircraft which includes a control panel 101 comprising various instrumentation and controls and a pitch and roll control device 102 comprising a steering wheel 104 connected to a transfer arm 106 that transfers force applied to the steering wheel 104 to control structure 110 that is typically located beneath the pilot 108. As shown, the transfer arm 106 is located between the legs of the pilot 108.

The transfer arm 106 is configured to rotate about a center of rotation 120 located beneath the pilot.

FIG. 2 illustrates an exemplary cockpit 200 of a commercial aircraft which includes a control panel or frame 201 comprising various instrumentation and controls and a pitch and roll control device 202 comprising the inventive subject matter discussed herein. The device 202 comprises a steering wheel 204 coupled with the control panel 201 and constrained to move in a forward and aft direction using a linkage mechanism 206. The linkage mechanism 206 preferably transfers force applied to the steering wheel 204 to control structure 210 that controls a pitch of an aircraft. Due to the reduced size of the structure 210 required, it is contemplated that the control structure 210 can be located in the control panel 201 rather than beneath the pilot 208.

As shown, the inventive subject matter allows the transfer arm 106 shown in FIG. 1 to be eliminated, while maintaining the center of rotation of the steering wheel 204 relative to the aircraft.

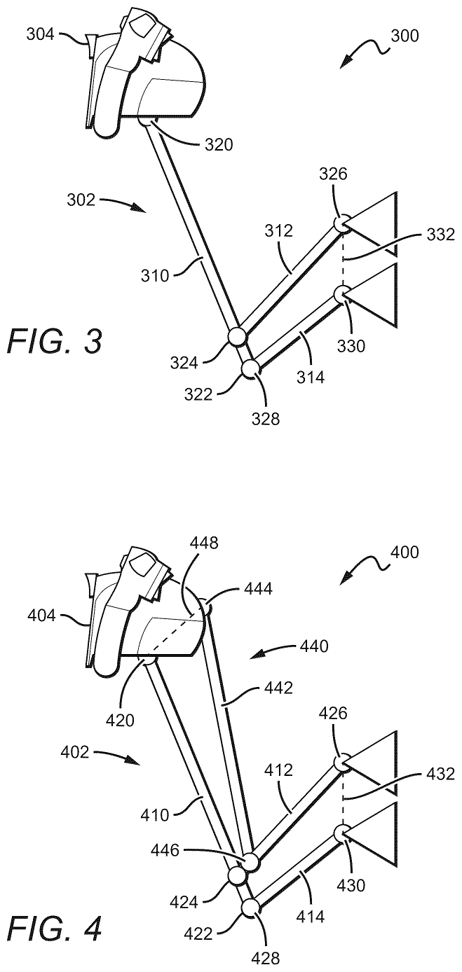

FIG. 3 illustrates one embodiment of a linkage mechanism 302 for a pitch and roll input control device 300 for an aircraft, such as shown in FIG. 2. The linkage mechanism 302 comprises a first linkage 310, a second linkage 312, and a third linkage 314. As shown, the first linkage 310, the second linkage 312, and third linkage 314 are coupled together such that movement of one of the linkages causes corresponding movement of the other linkages. In this manner, movement of the steering wheel 304 in the forward or aft direction causes movement of the linkage mechanism 302 which interacts with control structure of the aircraft to thereby cause a change in the pitch of the aircraft.

The first linkage 310 is fixed to the steering wheel 304 at a first end 320 and is rotatably coupled to the third linkage 314 at a second end 322. The second linkage 312 is rotatably coupled to the first linkage 310 at a first end 324 and is rotatable at a second end 326 that is fixed in position to the aircraft. The third linkage 314 is rotatably coupled to the first linkage 310 at a first end 328 and is rotatable at a second end 330 that is fixed in position to the aircraft. As shown, the second end of the first linkage 310 and the first end 328 of the third linkage 314 are rotatably coupled to one another and pivot about the same axis. The first end 324 of the second linkage 312 and the first end 328 of the third linkage 314 are coupled to the first linkage 310 at different points along the first linkage 310.

It is further contemplated that the linkage mechanism 302 comprises a virtual fourth linkage 332 that constrains movement of the second end 326 of the second linkage 312 and the second end 330 of the third linkage 314.

FIG. 4 illustrates another embodiment of a linkage mechanism 402 for a pitch and roll input control device 400 for an aircraft. Similar to the mechanism shown in FIG. 3, linkage mechanism 402 comprises a first linkage 410, a second linkage 412, and a third linkage 414, which are coupled together such that movement of one of the linkages causes corresponding movement of the other linkages. In this manner, movement of the steering wheel 404 in the forward or aft direction causes movement of the linkage mechanism 402 which interacts with control structure of the aircraft to thereby cause a change in the pitch of the aircraft.

The first linkage 410 is fixed to the steering wheel 404 at a first end 420 and is rotatably coupled to the third linkage 414 at a second end 422. The second linkage 412 is rotatably coupled to the first linkage 410 at a first end 424 and is rotatable at a second end 426 that is fixed in position to the aircraft. The third linkage 414 is rotatably coupled to the first linkage 410 at a first end 428 and is rotatable at a second end 430 that is fixed in position to the aircraft. As shown, the second end of the first linkage 410 and the first end 428 of the third linkage 414 are rotatably coupled to one another and pivot about the same axis. The first end 424 of the second linkage 412 and the first end 428 of the third linkage 414 are coupled to the first linkage 410 at different points along the first linkage 410.

It is further contemplated that the linkage mechanism 402 comprises a virtual fourth linkage 432 that constrains movement of the second end 426 of the second linkage 412 and the second end 430 of the third linkage 414.

Device 400 further comprises a tilt linkage mechanism 440 configured to constrain a tilt of the steering wheel 404 with respect to the aircraft while the steering wheel 404 is being moved in an aft or forward direction. The tilt linkage mechanism 440 allows the steering wheel 404 to be adjusted and oriented at an optimum angle to be comfortably operated by the pilot. The tilt linkage mechanism 440 preferably comprises a fifth linkage 442 that is coupled to the steering wheel 404 at a first end 444 and is rotatably coupled to the second linkage 412 at a second end 446. It is contemplated that the tilt linkage mechanism 440 further comprises a virtual sixth linkage 448 (here, the steering wheel 404) that constrains movement of the first end 444 of the fifth linkage 442 and the first end 420 of the first linkage 410.

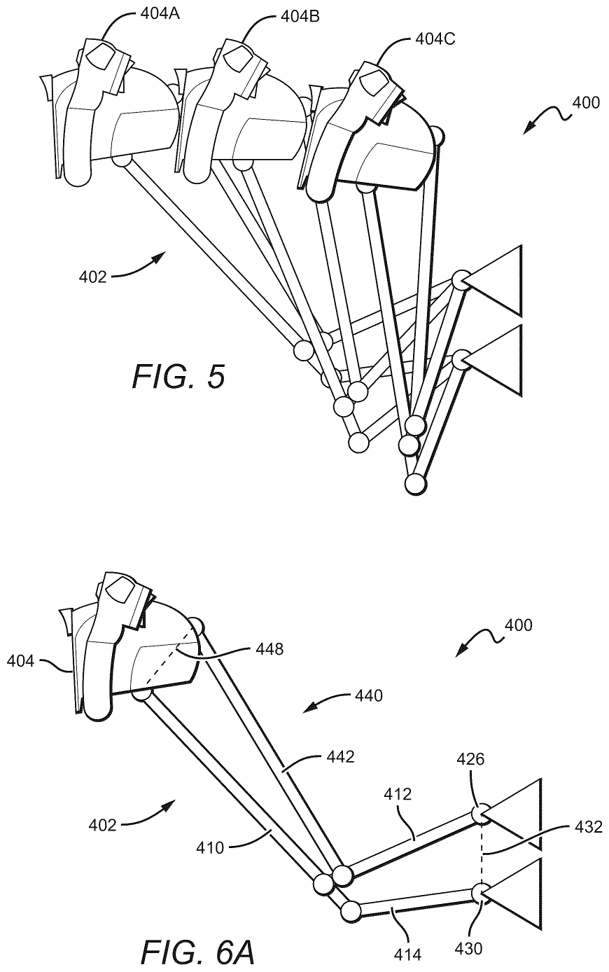

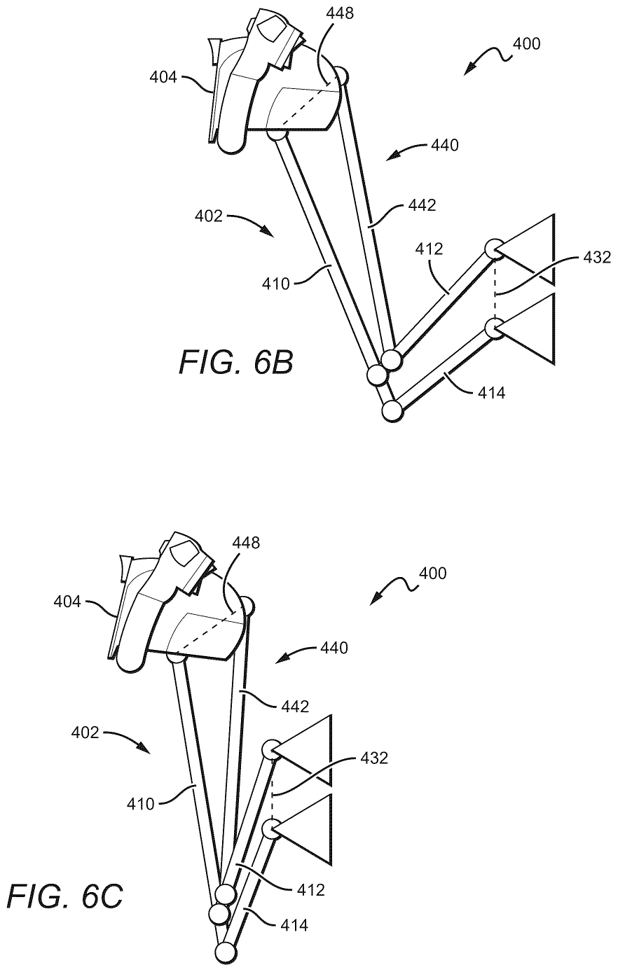

FIG. 5 illustrates the pitch and roll input control device 400 described above and shown in FIG. 4 as the steering wheel moves from a first position 404A to a second position 404B to a third position 404C. As can be seen, movement of the steering wheel 404A-404C in the forward direction causes movement of the linkage mechanism 402, which translates the movement of the steering wheel to the aircraft's system to thereby cause a change in pitch of the aircraft. This is also shown in FIGS. 6A-6C, which are described below.

FIGS. 6A-6C illustrates the pitch and roll input control device 400 described above and shown in FIGS. 4-5 as the steering wheel moves from a first position 404A to a second position 404B to a third position 404C.

FIGS. 6A-6C illustrates the pitch and roll input control device 400 comprising linkage mechanism 402. As discussed above, linkage mechanism 402 comprises a first linkage 410, a second linkage 412, and a third linkage 414, which are coupled together such that movement of one of the linkages causes corresponding movement of the other linkages. The linkage mechanism 402 further comprises a virtual fourth linkage 432 that constrains movement of the second linkage 412 and the third linkage 414.

Device 400 further comprises a tilt linkage mechanism 440 configured to constrain a tilt of the steering wheel 404 with respect to the aircraft. The tilt linkage mechanism 440 preferably comprises a fifth linkage 442 that is coupled to the steering wheel 404 and is rotatably coupled to the second linkage 412. The tilt linkage mechanism 440 further comprises a virtual sixth linkage 448 (here, steering wheel 404) that constrains movement of the fifth linkage 442 and the first linkage 410.

When comparing FIG. 6A to FIG. 6B and FIG. 6C, movement of the steering wheel 404 in the forward (or aft) direction causes movement of the linkage mechanism 402 and each of the linkages. In this manner, the linkage mechanism 402 transfers movement of the steering wheel 404 to control structure of the aircraft to thereby cause a change in the pitch of the aircraft.

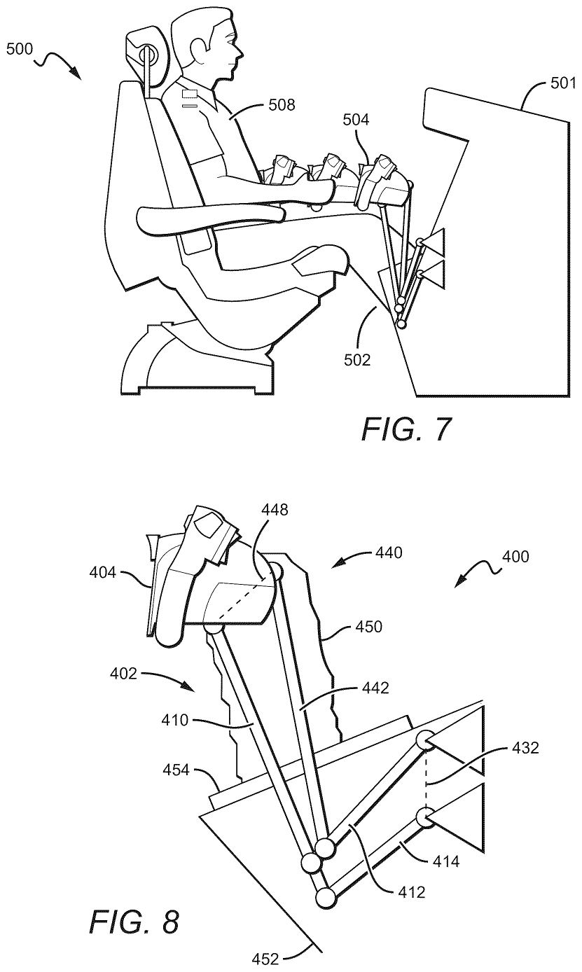

FIG. 7 illustrates an exemplary cockpit 500 of a commercial aircraft which includes a control panel or frame 501 comprising various instrumentation and controls. A pitch and roll control device 502 is preferably mounted to the frame 501. The device 502 comprises a steering wheel 504 coupled with the frame 501 and constrained to move in a forward and aft direction using a linkage mechanism 506. Exemplary linkage mechanisms are discussed above.

The linkage mechanism 506 preferably transfers force applied to the steering wheel 504 to control structure that controls a pitch of an aircraft. Due to the reduced size of the structure required, it is contemplated that the control structure can be located in the control panel 501 rather than beneath the pilot 508.

FIG. 8 illustrates the control device 400 described above with respect to FIG. 4. As previously discussed, the control device 400 comprising a linkage mechanism 402 with a plurality of linkages that are coupled together such that movement of one of the linkages causes corresponding movement of the other linkages. Linkage mechanism 402 comprises a first linkage 410, second linkage 412, third linkage 414, and a virtual fourth linkage 432. Device 400 further comprises a tilt linkage mechanism 440 configured to constrain a tilt of the steering wheel 404 with respect to the aircraft. The tilt linkage mechanism 440 comprises a fifth linkage 442 and a virtual sixth linkage 448.

As shown in FIG. 8, the upper portion of the linkage mechanism 402 can be covered by a bellows or other covering 450, which permits movement of the linkages of the linkage mechanism 402 while preventing objects from being placed between the linkages (e.g., linkages 410, 442). The bellows 450 also helps prevent entry of dust, debris and other objects which could potentially cause the linkage mechanism 402 to fail.

It is further contemplated that the lower portion of the linkage mechanism 402 can be protected by a casing 452 or other structure having a sliding shutter 454 or other mechanism which allows for movement of the linkages of the linkage mechanism 402 while preventing entry of objects into the casing 452.

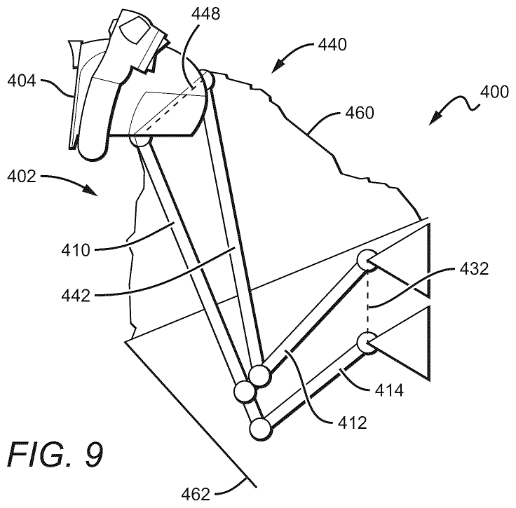

FIG. 9 illustrates an alternative embodiment of a protective cover for a linkage mechanism of a pitch and roll control device for an aircraft. The control device 400 may be similar to that described above with respect to FIG. 4. As previously discussed, the control device 400 comprising a linkage mechanism 402 with a plurality of linkages that are coupled together such that movement of one of the linkages causes corresponding movement of the other linkages. Linkage mechanism 402 comprises a first linkage 410, second linkage 412, third linkage 414, and a virtual fourth linkage 432. Device 400 further comprises a tilt linkage mechanism 440 configured to constrain a tilt of the steering wheel 404 with respect to the aircraft. The tilt linkage mechanism 440 comprises a fifth linkage 442 and a virtual sixth linkage 448.

As shown in FIG. 9, the upper portion of the linkage mechanism 402 can be covered by a bellows or other covering 460, which permits movement of the linkages of the linkage mechanism 402 while preventing objects from being placed between the linkages (e.g., linkages 410, 442). The bellows 460 also helps prevent entry of dust, debris and other objects which could potentially cause the linkage mechanism 402 to fail. Compared with the covering 450 of FIG. 8, the bellows 460 is larger in volume to cover the entire area where the linkages extend through the casing 462.

It is further contemplated that the lower portion of the linkage mechanism 402 can be protected by the casing 462 or other structure. This combined with the bellows 460 allows for movement of the linkages of the linkage mechanism 402 while preventing entry of objects into the casing 462.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A pitch and roll input control device for an aircraft, comprising:
a frame;
a steering wheel coupled with the frame and constrained to move in a forward and aft direction using a linkage mechanism;
wherein the linkage mechanism comprises a first linkage, a second linkage, and a third linkage, wherein the first, second, and third linkages are coupled together such that movement of one of the linkages causes corresponding movement of the other linkages;
wherein the first linkage is coupled to the steering wheel at a first end, wherein the second linkage is rotatably coupled to the first linkage at a first end and is rotatable at a second end that is fixed in position, and wherein the third linkage is rotatably coupled to the first linkage at a first end and is rotatable at a second end that is fixed in position; and
wherein movement of the steering wheel in the forward or aft direction causes movement of the linkage mechanism to thereby cause a change in pitch of an aircraft.

2. (canceled)

3. The device of claim 1, wherein the second linkage is rotatably coupled to a second end of the first linkage.

4. The device of claim 1, wherein the first end of the second linkage and the first end of the third linkage are coupled to the first linkage at different points.

5. The device of claim 1, wherein the linkage mechanism further comprises a virtual fourth linkage configured to constrain movement of the second end of the second linkage and the second end of the third linkage.

6. The device of claim 5, further comprising a tilt linkage mechanism comprising a fifth linkage configured to constrain a tilt of the steering wheel with respect to the aircraft.

7. The device of claim 6, wherein the fifth linkage is coupled to the steering wheel at a first end and is rotatably coupled to the second linkage at a second end.

8. The device of claim 7, wherein the tilt linkage mechanism further comprises a virtual sixth linkage that constrains movement of the first end of the fifth linkage and the first end of the first linkage.

9. The device of claim 8, wherein the steering wheel acts as the virtual sixth linkage.

10. The device of claim 1, further comprising a bellow or casing configured to cover at least a portion of the linkage mechanism.

11. The device of claim 1, wherein the steering wheel is fixed to the first linkage.

12. A pitch and roll input control device for an aircraft, comprising:
a frame;
a steering wheel coupled with the frame and constrained to move in a forward and aft direction using a linkage mechanism;
wherein the linkage mechanism comprises a first linkage, a second linkage, and a third linkage, wherein the first, second, and third linkages are coupled together such that movement of one of the linkages causes corresponding movement of the other linkages;
a tilt linkage mechanism comprising a fifth linkage configured to constrain a tilt of the steering wheel with respect to the aircraft, wherein the fifth linkage is coupled to the steering wheel at a first end and is rotatably coupled to the second linkage at a second end; and
wherein movement of the steering wheel in the forward or aft direction causes movement of the linkage mechanism to thereby cause a change in pitch of an aircraft.

13. The device of claim 12, wherein the first linkage is coupled to the steering wheel at a first end, wherein the second linkage is rotatably coupled to the first linkage at a first end and is rotatable at a second end that is fixed in position, and wherein the third linkage is rotatably coupled to the first linkage at a first end and is rotatable at a second end that is fixed in position.

14. The device of claim 13, wherein second linkage is rotatably coupled to a second end of the first linkage.

15. The device of claim 13, wherein the first end of the second linkage and the first end of the third linkage are coupled to the first linkage at different points.

16. The device of claim 13, wherein the linkage mechanism further comprises a virtual fourth linkage configured to constrain movement of the second end of the second linkage and the second end of the third linkage.

17. The device of claim 12, wherein the tilt linkage mechanism further comprises a virtual sixth linkage that constrains movement of the first end of the fifth linkage and the first end of the first linkage.

18. The device of claim 17, wherein the steering wheel acts as the virtual sixth linkage.

19. The device of claim 12, further comprising a bellow or casing configured to cover at least a portion of the linkage mechanism.

20. The device of claim 12, wherein the steering wheel is configured to rotate about a first axis.
